(19) United States
(12) Patent Application Publication
(10) Pub. No.: US 2004/0117408 A1
(43) Pub. Date: Jun. 17, 2004

(54) Systems, methods and articles of manufacture for determining available space in a database

(75) Inventors: Santosh K. Bharadwaj, Glen Allen, VA (US); Nageswara R. Saripella, Richmond, VA (US)

Correspondence Address: Finnegan, Henderson, Farabow,, Garrett & Dunner, L.L.P., 1300 I Street, N.W., Washington, DC, 20005-3315, US

(73) Assignee: Capital One Financial Corporation

(21) Appl. No.: 10/320,496

(22) Filed: Dec. 17, 2002

(51) Int. Cl. G06F 17/30; G06F 12/00

(52) U.S. Cl. 707/200

(57) ABSTRACT

Methods, systems, and articles of manufacture are disclosed for facilitating database storage management. As disclosed herein, a computing system may determine a space availability for a segment included in a tablespace associated with a database. In one embodiment, the system may perform a vital statistics process that identifies a segment included in the tablespace and performs a dump process that collects segment information from a segment header included in the segment. Based on the dumped information, the vital statistics process may determine space availability information for the segment such as used space for the segment, fractional space used by the segment in relation to an amount of space of the tablespace, available free space for the segment, and/or a number of new rows that may be inserted into the segment. The computing system may also be configured to perform a trend analysis associated with a capacity pattern for the segment based on historical information including space availability information for the segment over a period of time. Based on the results of the trend analysis, the computing system may forecast the capacity of the segment and the tablespace.

### BACKGROUND OF THE INVENTION

1. Field of the Invention

The present invention generally relates to the fields and database storage management. More particularly, the invention relates to systems, methods and articles of manufacture for determining space availability information for a database system, such as space availability information related to a tablespace included in a database system.

2. Background and Material Information

Database Administrators (DBAs) are becoming key participants in information provisioning systems due to the increase in the availability of information provided by data sharing environments, such as the Internet. The dynamic nature of information maintained by database systems requires a DBA to constantly manage the structure of these systems to ensure requesting entities have efficient and accurate access to data. DBA management duties may include, for example, determining the amount of available space within a database to compensate for pending and potential access operations (e.g., writes, edits, deletions, etc.). To aid in their management tasks, DBAs may employ conventional management tools to determine the characteristics of a database at any given time. For example, Oracle™ database systems offer several database management tools that enable a DBA to compute various space components of an Oracle™ database. These tools include, for example, Dba_free_space, DBMS_SPACE, and Analyze command.

Dba_free_space provides an Oracle™ dictionary view used to calculate the overall free space available in a tablespace of a database. Generally, a tablespace is a virtual representation of storage space that includes one or more objects (e.g., tables) that store data. DBMS_SPACE is an Oracle™ supplied package that is used to determine the number of unused blocks above a High Water Mark (HWM) of a tablespace object, such as a table. A HWM is an indicator reflecting the last used space in a tablespace object. Space above the HWM generally includes unused data space, while space below the HWM includes used and freelist space. Freelist space is space that includes space that may have been used, but may be available for future data storage. DBMS_SPACE may also be used to determine the number of freelist blocks below the HWM.

Analyze command is another Oracle™ database management tool that compiles statistics on a table. The level of accuracy of the table statistics generally depends on one of two modes of the command. The first mode, estimate analyze command, analyzes a relatively small sample of rows of a table to produce the table statistics. The second mode, compute analyze command, analyzes all of the rows of a table and is generally more accurate than the estimate analyze command mode, but requires more processing time.

Although database systems offer database management tools that provide a DBA with characteristic information associated with a database, they have several shortcomings. For instance, the above-noted Oracle™ database tools Dba_free_space, DBMS_SPACE, and Analyze command each have their own limitations. The Dba_free_space dictionary view only provides information associated with a tablespace freespace. Further, if there are multiple tablespace objects sharing the tablespace, it is difficult for a DBA to determine how much space each object may have access to. The DBMS_SPACE and Analyze command tools are inefficient because of the length of processing time required to produce an accurate result. Also, all three of these tools do not provide historical information associated with the characteristics of a database. Thus, a DBA may not become aware of unavailable space in a database in time to compensate for pending access requests.

In addition to the noted shortcomings of the above exemplary Oracle™ commands, other shortcomings and disadvantages exist with respect to conventional database management tools. For example, a DBA may be required to implement several tools or commands (such as all three of the noted Oracle™ commands) in order to obtain a more detailed view of the characteristics of a database. Such limitations of prior database management tools result in time consuming or inefficient efforts by DBAs who are required to manage one or more database systems.

Accordingly, there is a need for improved database management tools and processes for managing space in database systems. Moreover, there is a need for more powerful and efficient tools that permit DBAs to gather information necessary for effective database management. There is also a need for systems and methods that can determine, for example, accurate and detailed space availability information for a database in a more efficient manner than conventional database management tools. Furthermore, there is a need for database management systems and processes that can provide, for example, historical characteristic information for a database to permit a database trend analysis.

### SUMMARY OF THE INVENTION

Consistent with embodiments of the present invention, systems, methods and articles of manufacture are provided for facilitating database storage management. Embodiments of the invention include systems and methods that are adapted to determine information related to a database, such as the availability of space in the database. For example, in one embodiment, space availability determinations are performed to determine the space availability for a segment included in a tablespace associated with the database.

In accordance with an embodiment of the invention, a system is provided that performs a vital statistics process that identifies a segment included in a tablespace of a database and performs an internal dump process that collects segment information from a segment header included in the segment. Based on the dumped information, the vital statistics process may determine space availability information for the segment. The space availability information may include at least one of used space for the segment, fractional space used by the segment in relation to an amount of space of the tablespace, available free space for the segment, and a number of new rows that may be inserted into the segment. Further, the system may be configured to perform a trend analysis associated with a capacity pattern for the segment based on historical information including space availability information for the segment over a previous period of time. Based on the results of the trend analysis, the computing system may forecast the capacity of the segment and the tablespace.

In accordance with another embodiment, the computing system may determine the used space for the segment by determining a difference between a total number of blocks below a HWM and a number of freelist blocks for the segment. Further, the computing system may determine the fractional space used by the segment by dividing a total number of blocks below the HWM for the segment by a total number of blocks of all the segments in that tablespace. Additionally, the computing system may determine the available free space for the segment based on a difference value between a total allocated space for the segment and a number of blocks below the HWM for the segment, a first value reflecting a relationship between the number of free list blocks for the segment and a percentage used value for the segment, and a second value reflecting a relationship between a total number of free blocks in the tablespace and the fractional space used by the segment.

According to still another embodiment, the post dump process may include determining a number of rows based on a determination whether the segment has been analyzed by an analysis tool. If the segment has been analyzed by the tool, the computing system may be configured to obtain the number of rows from a dictionary table provided by the database. Alternatively, if the segment has not been analyzed, the computing system may determine the total number of rows for the segment by performing an index count or a full scan of the segment.

In yet another embodiment of the invention, the dump process may include determining whether the segment is partitioned. If the segment is not partitioned, the dump process may include collecting and dumping master free list information that reflects a total number of free blocks for a corresponding free list group included in a segment header. Alternatively, if the segment includes one or more partition segments (i.e., the segment is partitioned), the dump process may include dumping a partition segment header associated with each partition segment.

It is to be understood that both the foregoing general description and the following detailed description are exemplary and explanatory only, and should not be considered restrictive of the scope of the invention, as described. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this specification, illustrate various embodiments and aspects of the present invention. In the drawings:

FIG. 1 illustrates an exemplary system environment in which certain embodiments of the present invention may be implemented;

FIG. 2 is a block diagram of an exemplary virtual tablespace, consistent with embodiments of the present invention;

FIG. 3 shows a block diagram of an exemplary segment, consistent with embodiments of the present invention

FIG. 4 is a flowchart of an exemplary vital statistics dump process, consistent with embodiments of the present invention;

FIG. 5 is a block diagram of exemplary partitioned and non-partitioned segments, consistent with embodiments of the present invention;

FIG. 6 is a flowchart of an exemplary vital statistics post dump process, consistent with embodiments of the present invention;

FIG. 7 is a flowchart of an exemplary report generation process, consistent with embodiments of the present invention; and

FIG. 8 is a graph depicting an exemplary trend analysis of row growth for an exemplary table consistent with embodiments of the present invention.

### DETAILED DESCRIPTION

Embodiments of the present invention are directed to systems, methods and articles of manufacture for facilitating database storage management. Embodiments of the invention include systems and methods for determining and providing information related to a database, such as the availability of space in the database. In one embodiment, statistical information is determined for a tablespace of a database. The tablespace may comprise a free pool of space from which objects (e.g., tables) may be created and/or maintained.

In accordance with embodiments of the invention, a vital statistics process may be performed that collects information associated with the available and used space of a tablespace object, and determines tablespace statistical information based on the collected information. In one embodiment, the vital statistics process may determine the available space below a HWM of a tablespace object, the unused space above the HWM, the fractional space available in the tablespace, the actual used space of a tablespace object, the average row size of a tablespace object, and/or the current and future row count. Further, embodiments of the present invention may perform database trend analysis and capacity forecasting for potential and/or pending access operations.

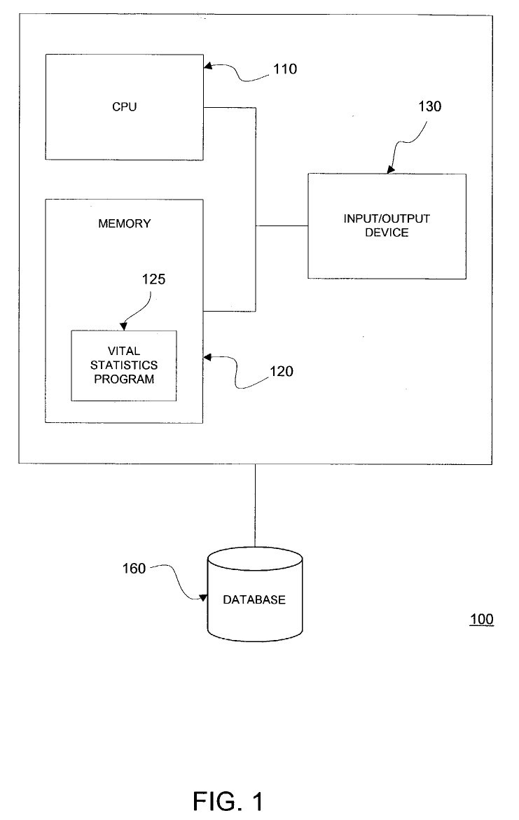

FIG. 1 illustrates an exemplary computing system 100 in which embodiments of the invention may be implemented. As shown, system 100 includes a number of components such as a central processing unit (CPU) 110, a memory 120, an input/output (I/O) device 130, and a database 160. These components may be implemented through various configurations. By way of example, an integrated platform (such as a workstation, personal computer, laptop, etc.) may be provided that comprises CPU 110, memory 120 and I/O device 130. In such a configuration, components 110, 120 and 103 may connected through a local bus interface and access to database 160 (implemented as a separate database system) may be facilitated through a direct communication link, a local area network (LAN), a wide area network (WAN) and/or other suitable connections.

CPU 110 may be one or more known processing devices, such as a microprocessor from the Pentium family manufactured by Intel™. Memory 120 may be one or more storage devices configured to store information used by CPU 110 to perform certain functions related to embodiments of the present invention. Memory 120 may be a magnetic, semiconductor, tape, or optical type of storage device. In one embodiment, memory 120 includes one or more programs that, when executed by CPU 110, perform various processes consistent with embodiments of the present invention. For example, memory 120 may include a vital statistics program 125 that, when executed by CPU 110, determines and provides statistical information associated with database 160. Memory 120 may also include other programs that perform other functions consistent with embodiments of the invention. Moreover, methods, systems, and articles of manufacture consistent with embodiments of the present invention are not limited to programs configured to perform dedicated tasks. For example, memory 120 may be configured with a program that performs several functions when executed by CPU 110. That is, memory 120 may include a program for collecting pre-dump information from database 160 and a program for determining statistical information of database 160 based on the collected pre-dump information. Alternatively, CPU 110 may execute one or more programs located remotely from system 100. For example, system 100 may access one or more remote programs that, when executed, perform functions related to embodiments of the present invention.

I/O device 130 may comprise one or more input/output devices that allow data to be received and/or transmitted by system 100. For example, I/O device 130 may include one or more input devices, such as a keyboard, touchscreen, mouse, and the like, that enable data to be input from a user. Further, I/O device 130 may include one or more output devices, such as a display screen, printer, speaker devices, and the like, that enable data to be output or presented to a user. The configuration and number of input and/or output devices incorporated in I/O device 130 may vary without departing from the scope of the invention.

Database 160 may comprise one or more databases that store information and that is accessed and managed through system 100. By way of example, database 160 may be an Oracle™ database, a Sybase™ database, or any other known type of database and/or database system. For purposes of illustration, the following description of embodiments of the invention will be described with database 160 implemented as an Oracle™ database. Those skilled in the art, however, will appreciate that embodiments of the present invention, including the exemplary vital statistic processes, may be applied to other types of database and memory systems.

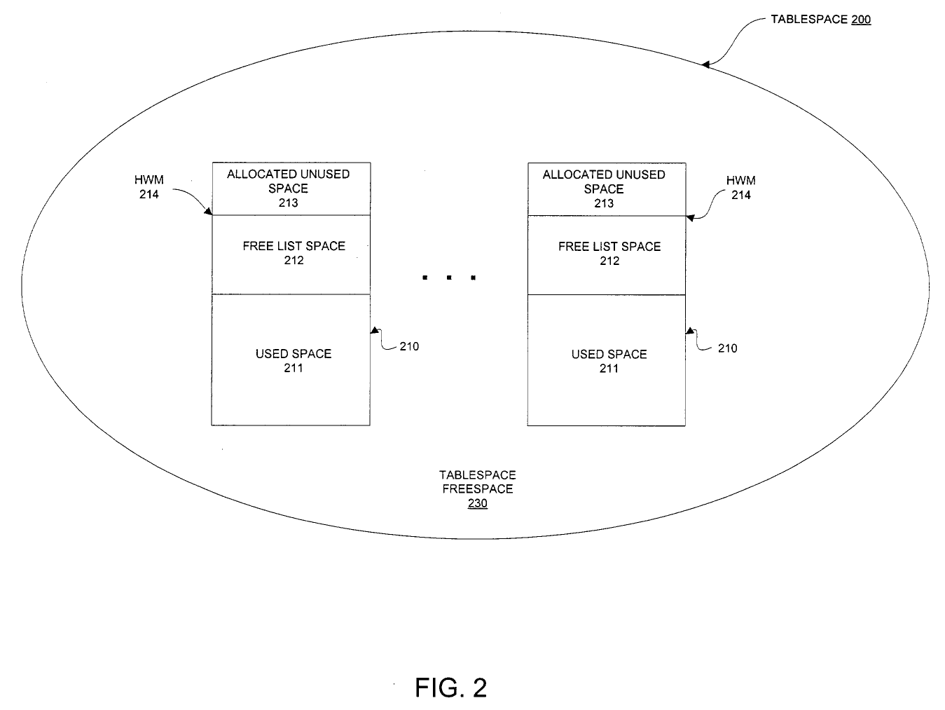

In one embodiment of the invention, system 100 may configure information stored in database 160 as Oracle™ tablespace objects. Such tablespace objects may be part of a tablespace corresponding to database 160. Such a tablespace may be configured in accordance with the exemplary tablespace disclosed herein with reference to FIG. 2.

FIG. 2 illustrates a diagram of an exemplary tablespace 200. Tablespace 200 may reflect a virtual data space associated with information stored in database 160. Tablespace 200 may include one or more tablespace objects. In one embodiment of the invention, tablespace 200 includes one or more segments 210. A segment is a type of tablespace object and may be categorized as a table, index, rollback, or temporary tablespace object.

A table is a tablespace object that includes data that may be accessed and/or modified. An index is a tablespace object that includes one or more indexes that are pointers to information in a corresponding table object. System 100 may use an index to directly access data stored in a corresponding table object. A rollback segment is a database object that stores previous image of a transaction or operation (e.g., read, write, erase, etc.) for recovery purposes and to rollback a transaction. A temporary segment is a database object that includes data that is temporarily maintained in tablespace 200.

Each segment 210 includes space that is used to store information. The space is divided into different areas which may dynamically change in size based on different types of database operations performed in the respective area, such as read, write, and erase operations. As shown in FIG. 2, segment 210 may include a used space 211, a free list space 212, and an allocated unused space 213. Used space 211 reflects space in segment 210 that currently stores information (e.g., data that may be read or written). Free list space 212 reflects space in segment 210 that is a pool of free space for data to be stored. Further, the HWM 214 for each segment 210 represents the last used space in each corresponding segment 210.

Segment space may be assigned (i.e., moved) from used space 211 to free list space 212 when system 100 accesses used space 211 to store information, and then later makes the used space available for storing new data, such as when a used space is cleared of information based on a delete operation. Allocated unused space 213 is segment space that has been allocated to segment 210 but not yet used by system 100 to store information. Accordingly, the overall free space of database 160 may be the sum of free list space 212, allocated unused space 213, and tablespace freespace 230, which represents any remaining free space in tablespace 200 that may be used to create new tablespace objects 210. For example, tablespace 200 may include 90 Gbytes of space, while one or more segments (e.g., tables) included in tablespace 200 may only take up 30 Gbytes of space, leaving 60 Gbytes of free tablespace 230.

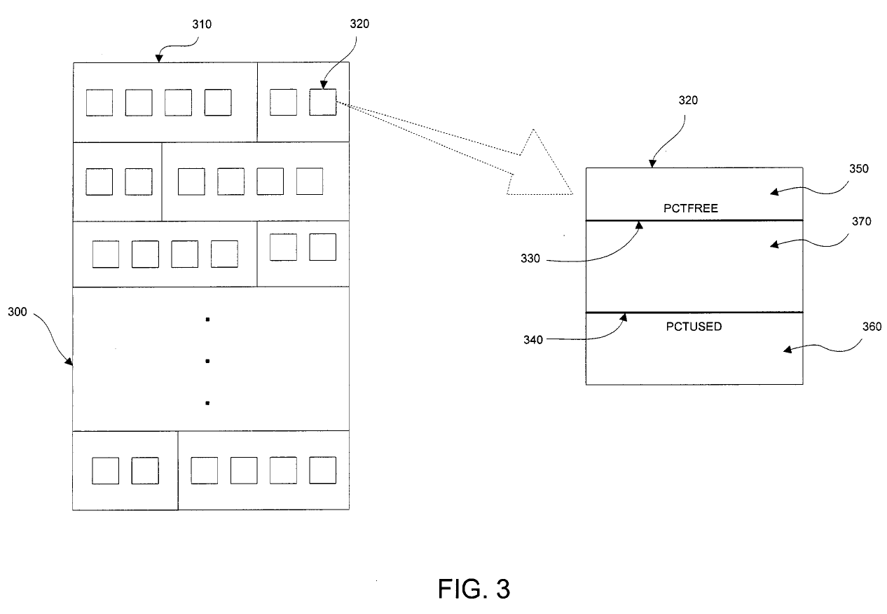

Each segment 210 may be structured based on various groupings of information. By way of example, FIG. 3 illustrates a block diagram of an exemplary segment 300 corresponding to one of the tablespace objects 210. As shown, segment 300 may include one or more extents 310. An extent 310 is a grouping of blocks 320. A block 320 is a unit of storage associated with segment 300. A block 320 may have different sizes, such as 2 Kilobytes, 8 Kilobytes, 16 Kilobytes, etc. In one embodiment, blocks 320 may have 16K of space for storing information. Each block 320 may have an associated Percentage Free (PCTFree) and Percentage Used (PCTUsed) parameter, shown as threshold levels 330 and 340, respectively. PCTFree may be a parameter set by a user (e.g., a user or DBA) that reflects a percentage of the space of block 320 that is to be left empty by system 100 when the block is initially filled with data (e.g., reference number 350). The empty space may be reserved for future updates to any information stored in block 320. Accordingly, as block 320 is filled with data, the amount of available space in the block is reduced. System 100 may allow block 320 to be filled with data up to the PCTFree threshold 330. Once block 320 is filled with data up to PCTFree threshold 330, system 100 may then associate the block with used space 211.

PCTUsed may be a parameter set by a user that reflects a percentage of the space in block 320 that, when data falls below, allows new data (e.g., rows) to be stored in block 320. For example, block 320 may include data stored in space 370 (below PCTFree space 350). Accordingly, this exemplary block 320 may be associated with used space 211 and only modification or updates of data in block 320 will be processed by system 100. However, when system 100 removes data in block 320 to a point where the data in block 320 falls below PCTUsed 340 and into space 360, block 320 may be used to store new data (e.g., new rows). Accordingly, system 100 may associate this exemplary block with free list space 212 instead of used space 210. Further, if data is added to block 320 that causes the used space of the block to surpass the PCTUsed 340 parameter, system 100 may then associate block 320 with used space 211. Thus, using PCTFree and PCTUsed parameters, a user (e.g., a DBA) may control how segment 300 may store data at a block level of granularity. In one embodiment, each segment (e.g., table) 210 in tablespace 200 may have different values for the PCTFree and PCTUsed parameters for their corresponding blocks. Therefore, each segment in tabelspace 200 may be associated with their own respective PCTFree and PCTUsed parameter values. Moreover, the values for these parameters may be dynamically adjusted by a user or a program during runtime or offline (e.g., when access to database 160 is temporarily or permanently halted).

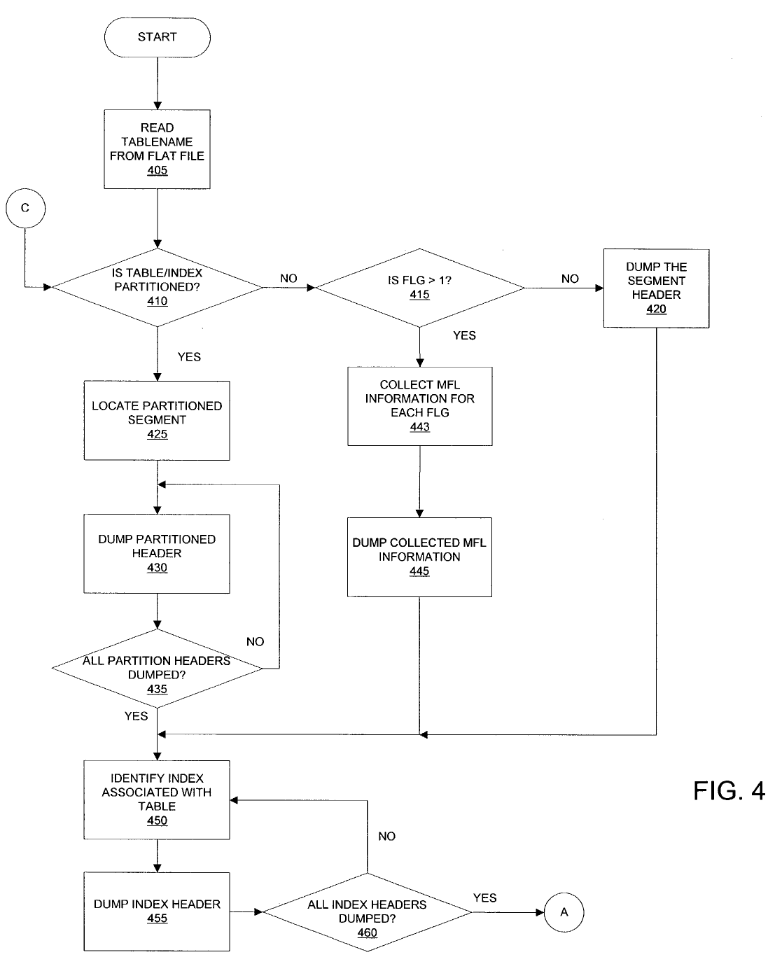

At some point in time, system 100 configures database 160 with segments 210 that store and/or may store information. During runtime, the efficiency and capacity of database 160 may change due to changes in the location and amount of data stored in the segments 210. Therefore, a user may wish to obtain a capacity report that reflects the space availability of segments 210 and database 160. Embodiments of the present invention enable system 100 to perform a vital statistics process that provides such capacity reports. FIGS. 4, 6, and 7 illustrate flowcharts of exemplary vital statistics process that may be performed by system 100.

FIG. 4 illustrates a flowchart of an exemplary vital statistics dump process, consistent with embodiments of the invention. In one embodiment, system 100 may begin the dump process by collecting the tablename from a flat file (Step 405). The flat file may be a data structure stored in a storage device (e.g., memory 120) that includes a list of tables or indices included in tablespace 200. Each table in the flat file may be identified by a unique tablename. For each table fetched from the flat file, the index or indexes associated with the table are fetched from a database data dictionary view.

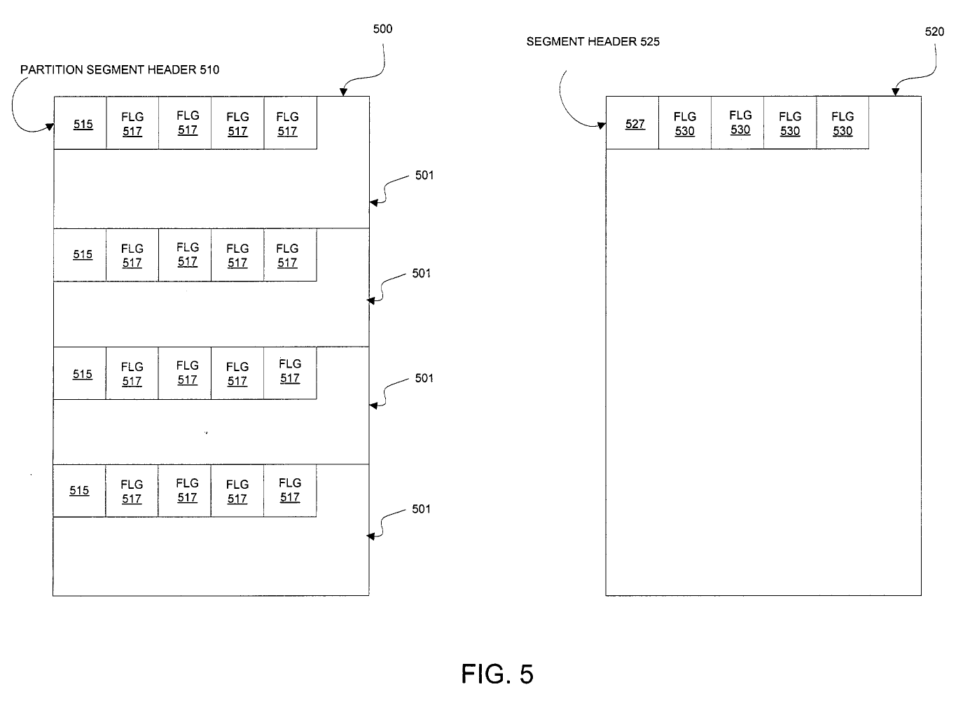

Once a table is identified by its name (e.g., tablename), system 100 may determine whether the segment is partitioned (Step 410). A partitioned segment, for example, is a segment that has been divided into a plurality of partitioned segments, each having their own partitioned segment header. A non-partitioned segment is a segment that has not been partitioned and may include a single segment header for the entire segment. FIG. 5 illustrates an exemplary representation of the differences between partitioned and non-partitioned segments.

As shown in FIG. 5, a partitioned segment 500 may include a plurality of partition segments 501. Each partition segment 501 may be configured to include used space (e.g., 211), free list space (e.g., 212), and allocated unused space (e.g., 213) associated with partition segment 501. Further, each partition segment 501 includes blocks of data (e.g., block 320) one or more of which may form a partition segment header 510. A partition segment header 510 includes information associated with its corresponding partition segment 501, such as the number of blocks in a partition segment 501, an indication of the HWM for the partition segment 501, the number of blocks below the HWM, the number of blocks allocated to partition segment 501, and/or the number of blocks in the free list space of the corresponding partition segment 501.

As further illustrated in FIG. 5, a non-partitioned segment 520 may also include a segment header 525 that provides information associated with data included in non-partitioned segment 520. By way of example, such information may include the number of blocks in a segment 520, an indication of the HWM for segment 520, the number of blocks below the HWM, the total number of blocks allocated to segment 520, and/or the number of blocks in the free list space of segment 520.

In one embodiment, segment header 525 and partition segment header 510 may be divided into a plurality of blocks. For example, partition segment header 510 may include a partition segment header block 512 that includes certain types of information associated with a corresponding partition segment 501 and one or more Free List Groups (FLGs) blocks 517. Each FLG 517 includes information associated with a group of free blocks within a corresponding partition segment 501. Thus, if partition segment header 510 includes fifty FLGs 517, there will be fifty corresponding groups of free blocks within a respective partition segment 501. Further, in one embodiment, each FLG 517 may include a Master Free List (MFL) that indicates the total sum of all free blocks for the corresponding FLG.

Similar to partition segment header 510, segment header 525 may also include a segment header block 527 and one or more FLGs 530 that each correspond to a group of free blocks within segment 520. In some instances, however, segment 520 may not define a FLG. In such a circumstance, segment 520 would instead define a MFL reflecting a total sum of all of the free blocks in segment 520 within the segment header 525.

Referring back to FIG. 4, if the table/index is not partitioned (Step 410; NO), system 100 determines whether there are more than one FLG in the segment header 525 (Step 415). If there is no FLG defined for segment 520 (Step 415; NO), system 100 may dump the segment header 525 of the corresponding segment (i.e., table or index) into a data structure (e.g., flat file) stored in a storage device (e.g., memory 120) (Step 420). The dumped segment header 525 is used by system 100 to determine total number of free blocks in segment 520 via the MFL included in segment header 525. In one embodiment of the invention, system 100 may format the information included in the segment header into an ASCII or text format prior to storing the information into the database. Once the segment header information is dumped, the vital statistics dump process may proceed to Step 450, described below.

On the other hand, if segment 520 includes more than one FLG (Step 415; YES), system 100 may collect the information reflected in the MFL for each of the FLGs included in the segment header 525 (Step 443). System 100 uses the collected MFL information to determine the total number of free blocks in segment 520. Accordingly, once the MFL information for each FLG is collected, system 100 may dump the collected MFL information to a data structure (e.g., flat file) stored in a storage device (e.g., memory 120) (Step 445). System 100 may be configured to format the collected MFL data into an ASCII or text format prior to dumping to the storage device. Following the dump operation, the vital statistics dump process may proceed to Step 450, described below.

Returning to Step 410 of FIG. 4, if the segment (e.g., table or index) is partitioned (Step 410; YES), system 100 may locate and collect each partition segment 501 from the partitioned segment 500 (Step 425). Then, system 100 may locate each partition segment header 510 and dump the information from a partition segment header 510 (e.g., MFL for each FLG 517) for a corresponding partition segment 501 into a data structure (e.g., flat file) stored in a storage device (e.g., memory 120) (Step 430). System 100 repeats the dump process (Step 430) until all of the partition headers 525 in partition segment 500 are dumped (Step 435). Once all of the partition header 525 are dumped (Step 435; YES), the vital statistics dump process may proceed to Step 450.

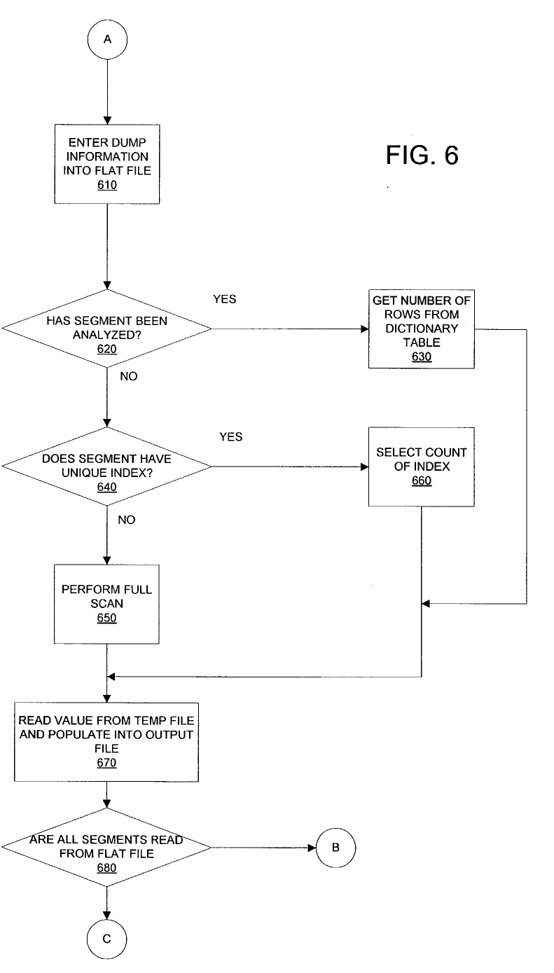

At Step 450, system 100 may identify and collect an index name associated with the table currently processed by the vital statistics dump process (Step 450). Subsequently, system 100 may dump the index header for the index corresponding to the collected index name into the data structure stored in the memory device. (Step 455). System 100 may then determine whether all index headers associated with the currently processed table have been collected and dumped (Step 460). If all index headers are not dumped, them Steps 450 and 455 are repeated for another identified index. On the other hand, if all of the indices associated with the table have been dumped, the vital statistics process continues to Step 610 (see FIG. 6).

FIG. 6 illustrates a flowchart of an exemplary vital statistics post dump process, consistent with embodiments of the present invention. As shown in FIG. 6, Step A from FIG. 4 continues with system 100 providing the information dumped in Steps 430, 445 or 420 into a data structure (e.g., flat file) (Step 610). The dumped information provided to the flat file may include, for example, the number of free blocks below the HWM for the corresponding segment being processed and the number of blocks in the free list portion (e.g., space 212) of the corresponding segment. Further, the dumped information may include the number of blocks below the HWM for the corresponding segment (e.g., the total number of blocks in spaces 211 and 212) and the total number of blocks allocated to the segment.

System 100 may also determine the total PCTFree and PCTUsed for the corresponding segment under analysis based on the PCTFree and PCTUsed information for each block included in the segment, and provide that determined information into the flat file. In one embodiment of the invention, the PCTFree and PCTUsed information for the corresponding segment may be obtained from dictionary tables, such as Oracle™ dictionary tables, that provide this information for each segment in tablespace 200.

During the vital statistics post dump process, system 100 may determine the total number of rows included in the segment under analysis. To do so, system 100 may first determine whether the segment (e.g., table) has been analyzed by a database analysis operation, such as the analyze command for Oracle™ type databases (Step 620). The analyze command determines database characteristic information for a segment (e.g., table) and provides this information into the dictionary table previously mentioned. The characteristic information may include a total number of rows for the segment (e.g., table), average row size, and/or free space information above and below the HWM for the corresponding segment. Accordingly, if the segment has already been analyzed, system 100 may collect this characteristic information from the dictionary table, such as the total number of rows for the segment, and store it in a temporary file located in a storage device (e.g., memory 120) (Step 630). System 100 may then populate the total number of rows information from the temporary file to a database table (Step 670).

In the event the segment has not been analyzed (Step 620; NO), system 100 may then automatically determine the total number of rows for the segment. To do so, system 100 may first determine whether the segment has been assigned a unique index (Step 640). A unique index is a pointer that is used by system 100 to locate and access particular data blocks within the segment. For example, a table may have a plurality of columns designated for storing certain types of information (e.g., employee name, manager name, etc.). System 100 may assign one or more of these columns with a unique index that enables the system to locate a particular row identifier from the table. Based on the row identifier, system 100 may locate and directly access a particular block of information within the table. Therefore, referring back to FIG. 6, if the segment does have a unique index (Step 640; YES), system 100 may perform a count of the index to obtain the total number of rows for the segment (Step 660). Once the number of rows is obtained, system 100 stores this information in a temporary file and proceeds to Step 670.

Obtaining the total number of rows for the segment using an index count is more efficient (e.g., less time consuming) than accessing all of the rows to count the number of rows. However, if the segment has not been analyzed and does not include a unique index, system 100 may have to perform such an operation. Accordingly, in Step 650, system 100 performs a full scan of the segment by accessing each row in the segment to obtain the total number of rows in the segment and stores the result in a temporary file. System 100 may then read the row count information from the temporary file and populate it into the database table (Step 670).

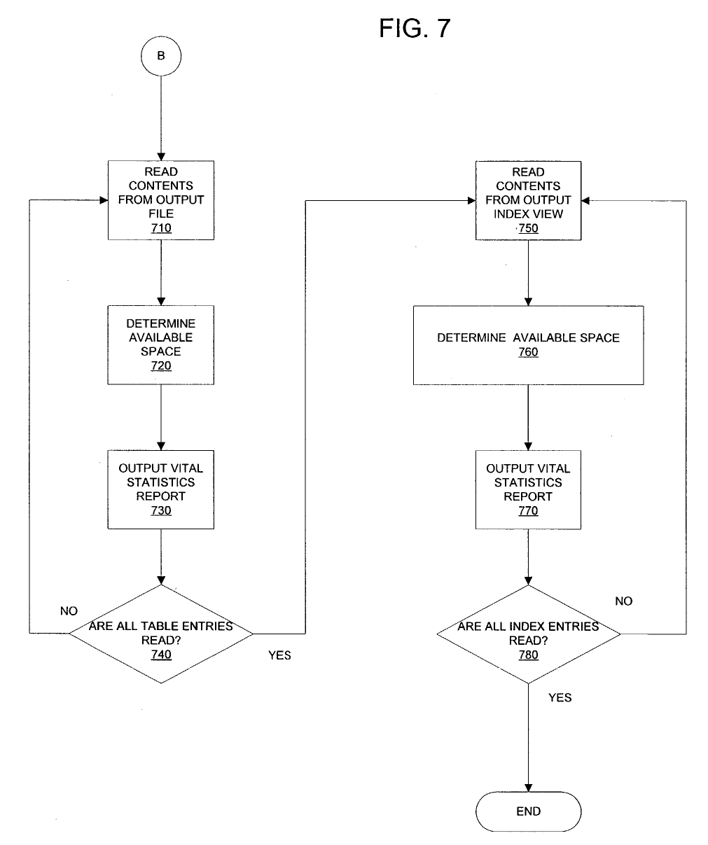

Once the total number of rows for the segment has been determined and stored in the database table, system 100 determines whether all of the segments have been processed (e.g., segment header information dumped) (Step 680). If not, system 100 locates another segment in tablespace 200 for dump and post dump processing (Step C). On the other hand, once all of the segments in tablespace 200 have been processed (Step 680; YES), system 100 executes a report generation process (Step B-see FIG. 7).

FIG. 7 illustrates a flowchart of an exemplary vital statistics report generation process, consistent with embodiments of the present invention. To generate a vital statistics report including the capacity and space availability information for database 160 (e.g., tablespace 200), system 100 may access the database table that contains the database information determined by, for example, the processes of FIGS. 4 and 6. In one embodiment, system 100 accesses the database table for table objects to collect the corresponding database information for the table (Step 710). Based on the accessed information from the table, system 100 may execute a program that calculates the space information for tablespace 200, including one or more of the exemplary information types described below.

Used Space for Each Segment (in Blocks)

To determine the used space in each segment (e.g., used space region 211), system 100 may determine the difference in the number of blocks between the free list space (e.g., space 212) and the total number of blocks below the HWM for the segment, which includes the free list space and the uses space for the segment (e.g., spaces 212 and 211). The number of blocks in the free list space and the total number of blocks below the HWM may be obtained from the information provided during a segment dump processes, such as that described with reference to FIG. 4. Accordingly, the used space for each segment may be represented mathematically as:

E=A−B,

where E is the used space per segment (in blocks), A is the total number of blocks below the HWM, and B is the number of free list blocks for the segment.

Row Size (in Blocks)

To determine the row size for a corresponding segment in tablespace 200, system 100 may divide the used space per segment by the total number of rows for the segment obtained using a process such as that described with reference to FIG. 6. Thus, the row size may be mathematically represented as:

R=E/C,

where R is the rows size of the segment in blocks, E is the used space per segment (in blocks), and C is the total number of rows for the segment.

Fractional Space Used by a Segment in Tablespace (Percentage)

System 100 may also determine the fractional space used by a segment in tablespace 200. The fractional space of a segment is associated with the amount of space used by the segment in relation to the total amount of tablespace 200. For example, assume there is 100 Gbytes of space in the tablespace 200. Further, assume that one of the exemplary segments 210 in tablespace 200 uses 7 GBytes of space (e.g., 7 GBytes of used space below the segment's HWM). Accordingly, the exemplary segment 210 uses 7% of the space in tablespace 200. Thus, if the exemplary segment 210 is the only tablespace object in tablespace 200, the total available space in tablespace 200 is 93 Gbytes. System 100 may be configured to determine the fractional space used by each segment in tablespace 200 by collecting the used space below the segment's HWM (e.g., variable A) and dividing this value by the sum of all of the used space associated with every segment in tablespace 200. Shown mathematically, the fractional space used by a segment in tablespace 200 (in blocks) may be:

F=A/Σ(A) for the tablespace,

where F is the fractional space used by a segment (in blocks), A is the number of blocks below the segment's HWM, and Σ(A) is the sum of all of the blocks below each segments HWM in tablespace 200.

Available Free Space Per Segment (in Blocks)

In one embodiment, system 100 may also determine the available free space for each segment in tablespace 200 based on the fractional space used by the segment (e.g., variable F). To determine the available space per segment, system 100 may determine the difference between the total allocated space for the segment and the number of blocks below the HWM for the segment. Further, system 100 determines the relationship between the number of freelist blocks in the segment and a variable associated with the PCTUsed value for the segment. This relationship can be represented mathematically as:

B*(1−PCTUsed)/100,

where B is the number of free list blocks for the segment and PCTUsed is the value associated with the PCTUsed value defined for the segment (e.g., 40%).

Also, system 100 determines another relationship between the total number of free blocks in tablespace 200 and the fractional space used by the segment (e.g., variable F). This relationship may be represented mathematically as:

G*F,

where G is the total free blocks in the tablespace and F is the fractional space used by a segment in tablespace 200.

System 100 may collect the above determined relationships and sum them together to determine the available free space for each segment in tablespace 200. This may be shown mathematically as:

H=((D−A)+(B*(1−PCTUsed)/100)+(G*F)),

where H is the available free space per segment, D is the total allocated space for the segment, A is the number of blocks below the HWM for the segment, B is the freelist blocks for the segment, G is the total free blocks in the tablespace, and F is the fractional space used by the segment.

Future Rows that can Fit into a Segment

System 100 may also determine the number of rows that may be used for storing data in a segment based on the available free space for the segment (e.g., variable H) and the size of the rows in the segment (e.g., variable R). Mathematically, this relationship may be represent as:

I=H/R,

where I is the number of rows that may be used for storing data for the segment, H is the available free space for the segment, and R is the row size for the segment.

Referring back to FIG. 7, once system 100 has determined one or more of the above described database capacity information, a vital statistics report may be created and provided to I/O device 130 (Step 730). System 100 may generate the report in different formats based on the type of report to be provided by Input/Output device 130. For example, system 100 may configure the report as a text file for printing on a printer or display device. Alternatively, the report may be configured as a e-mail message and provided to one or more e-mail addresses (e.g., DBA e-mail address). Further, system 100 may configure the vital statistics report as a graphical message that may be provided on a Web site by a Web server (not shown). Accordingly, based on the medium used to provide the report, system 100 may provide the space availability information included in the report to a Web server, an electronic mail server, a wireline or wireless telephonic based computer system (for automated voice messages, paging services, etc.), a display device for local display to a user, etc. One skilled in the art will appreciate that the type and format of the vital statistics report may vary without departing from the scope of the present invention.

Once system 100 provides the vital statistics report for a particular table, system 100 may determine whether there any more table entries in the input file associated with other table objects that have been read (Step 740). Such a determination may be made by determining if all table entries have been read which were processed by the vital statistics processes, such as those shown in FIGS. 4 and 6. If there are more table entries to process (Step 740; NO), the report generation process continues at Step 710. On the other hand, if all of the table objects have been processed (Step 740; YES), system 100 accesses any database information associated with an index object that may be stored in the output file (Step 750). System 100 may then calculate the available space for information for the index object in a manner similar to that described with respect to Step 720 (Step 760). Once the index space information is determined for the index object, system 100 may generate and provide a vital statistics report to I/O device 130 in a manner similar to that described with respect to Step 730 (Step 770). System 100 then determines whether there are any more index objects that have not been processed by the report generation process (Step 780), and if so, the process continues at Step 750. However, if system 100 has provide a report for each index object included in tablespace 200 (Step 780; YES), the report generation process ends.

Capacity Forecasting

In addition to providing space availability information for a database, system 100 may be configured to perform trend analysis and capacity forecast processes to determine the growth of segments in tablespace 200 based on current space availability information provided by the vital statistics report process described above. In one embodiment of the invention, system 100 may collect historical space availability information for the segments in tablespace 200 over a period of time (e.g., 24 hours, past week, past month, etc.). Based on the historical space availability information, system 100 may determine a relationship that reflects a representation of the growth of the segments in tablespace 200. For example, system 100 may generate an analysis graph that reflects the changes in the space of each segment in tablespace 200 over a period of time. In one embodiment, system 100 may format and provide the historical space availability information in a graph which is presented to a user (e.g., a DBA) operating system 100 via input/output device 130. The user may use the historical information to determine future space allocations for each segment in tablespace 200. Alternatively, system 100 may provide the historical information to a capacity forecast program that, when executed by CPU 110, automatically determines future space allocations for each segment in tablespace 200. For example, assume an exemplary segment in tablespace 200 has a fractional used space value (e.g., variable F) of 7% and the remaining free tablespace in tablespace is 60 GBytes. Based on the above assumptions, capacity forecast program may allocate only 7% of the 60 GBytes of free tablespace to the exemplary segment for storing new blocks of information. Additionally, or alternatively, the capacity forecast program may adjust the future allocation of space for the exemplary segment based on the segment's historical growth pattern represented by its historical space information collected by system 100.

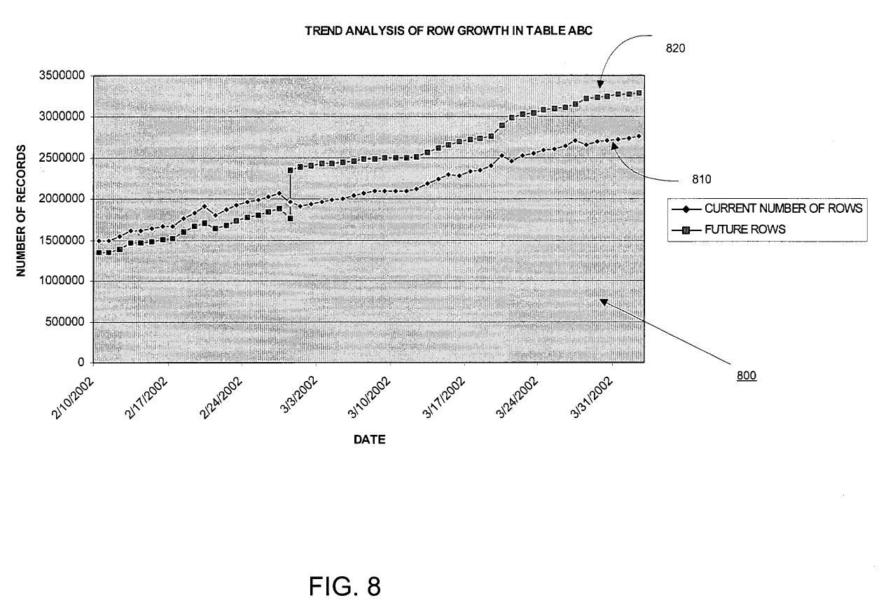

FIG. 8 shows a graph 800 depicting an exemplary trend analysis of row growth for an exemplary Table ABC that may be generated by system 100. As shown, based on the historical growth pattern of table ABC, system 100 may determine the number of future rows for the Table and present them in a graph 800. In one embodiment, system 100 may present a function representing a current number of rows 810 along with another function representing the determined future rows 820. The current number of rows function 810 may reflect the actual number of rows included in Table ABC at a respective point in time, such as the dates represented on the X-axis of graph 800. The corresponding future rows function 820 may reflect an estimated value of a new number of rows in Table ABC at the points in time represented on the x-axis. System 100 may determine the future rows function 820 based on the growth pattern of the rows included in Table ABC. For example, system 100 may retrieve historical row growth patterns for Table ABC from previous points in time to forecast the possible future number of rows for the exemplary Table. In one embodiment, system 100 may be configured to automatically execute the capacity forecast processes described above at any specified intervals of time using scheduler systems and software, such as Unix cron, ControlM, etc.

As described, embodiments of the present invention enable a system to overcome the inefficiencies of conventional database space determination tools. The vital statistics system and related methods consistent with embodiments of the present invention make use of information available in an internal segment header dumps, such as Oracle™ header dumps, tablespace free space information, and/or other dictionary information to generate availability information for one or more segments in a tablespace stored in a database system. The information included in the space availability report may be stored in a data structure (e.g., table) and used later for trend analysis and capacity forecasting.

The space availability information determined by system 100 include the space below the HWM for a segment in tablespace 200. The mathematical relationships used in the vital statistics process interprets information included in a segment header to provide an accurate view of available space below the HWM in the free list area (e.g., area 212) more efficiently than conventional database space availability tools, such as the DBMS_SPACE Oracle™ tool and the Estimate Analyze Command. Further, system 100 may determine the unused space above the HWM that has been allocated to the segment but never used (e.g., space 213).

Further, methods and systems consistent with embodiments of the invention overcome the shortcomings of the conventional database space availability tools by determining the fractional space available in tablespace 200. For example, the dba_free_space tool merely provides the overall free space in a tablespace. If the tablespace includes multiple tables and/or indexes, not all of the free space is available to one object in that tablespace. The vital statistics process may be used to determine the percentage of current space utilization of each of the segments in a tablespace and multiplies the percentage with the free space in the tablespace to determine the fraction of space available for all of the segments in the tablespace.

Additionally, system 100 may be configured to determine the actual used space of each segment in tablespace 200 (e.g., space 210) and the average row size of each segment. Further, system 100 may determine the average row size, the current number of rows in a segment, and an estimate of how may rows may fit into the segment in the future based on the free space availability information for the segment.

Also, because an index is generally smaller in size than a table, and a table is tightly linked to each of its indexes, system 100 provides space availability information for a table's indexes to plan for future growth of the table.

Other embodiments of the invention will be apparent to those skilled in the art from consideration of the specification and practice of the embodiments of the invention disclosed herein. Furthermore, although embodiments of the present invention are described as being associated with data stored in memory and other storage mediums, one skilled in the art will appreciate that these aspects can also be stored on or read from other types of computer-readable media, such as secondary storage devices, like hard disks, floppy disks, or CD-ROM; a carrier wave from the Internet; or other forms of RAM or ROM. Accordingly, it is intended that the specification and examples be considered as exemplary only, with a true scope and spirit of the invention being indicated by the following claims and their equivalents.

What is claimed is:

1. A method for determining space availability information for a tablespace of a database, comprising:
identifying a segment included in the tablespace;
performing a dump process to collect segment information from a segment header included in the segment; and
determining space availability information for the segment based on the segment information, wherein the space availability information includes at least one of used space for the segment, fractional space used by the segment in relation to an amount of space of the tablespace, available free space for the segment, and a number of new rows that may be inserted into the segment.

2. The method of claim 1, wherein determining space availability information comprises determining the used space for the segment by computing a difference between a total number of blocks below a High Water Mark (HWM) and a number of freelist blocks for the segment.

3. The method of claim 1, wherein determining space availability information comprises determining the fractional space used by the segment in relation to space used by all the segments in the tablespace, the determining the fractional space comprising:
computing a total number of blocks below a High Water Mark (HWM) for the segment; and
dividing the total number of blocks used by all the segments in the tablespace

4. The method of claim 1, wherein determining space availability information comprises determining the available free space for the segment, the determining the available free space for the segment comprising:
determining a difference value between a total allocated space for the segment and a total number of blocks below a High Water Mark (HWM) for the segment;
determining a first value reflecting a relationship between a total number of freelist blocks for the segment and a percentage used value for the segment, wherein the percentage used value reflects a threshold value for each block in the segment that controls whether the corresponding block may be used to store new data;
determining a second value reflecting a relationship between a total number of free blocks in the tablespace and the fractional space used by the segment; and
summing the difference value, the first value, and the second value to determine the available free space for the segment.

5. The method of claim 1, wherein determining space availability information comprises determining the number of new rows that may be inserted into the segment, the determining the number of new rows comprising:
determining a row size for the segment; and
dividing the unused space for the segment by the determined row size.

6. The method of claim 1, further comprising:
performing a post dump process to determine a total number of rows in the segment.

7. The method of claim 6, wherein performing a post dump process comprises:
determining the total number of rows in the segment based on a determination whether the segment has been analyzed by a database space availability analysis tool.

8. The method of claim 7, further comprising obtaining, if the segment has been analyzed by the database space availability analysis tool, the total number of rows for the segment from a dictionary table provided by the database space availability analysis tool.

9. The method of claim 7, further comprising performing, if the segment has not been analyzed by the database space availability analysis tool, a count of a unique index associated with the segment to determine the total number of rows for the segment.

10. The method of claim 7, further comprising performing, if the segment has not been analyzed by the database space availability analysis tool, a full scan of the segment to determine the total number of rows for the segment.

11. The method of claim 1, wherein performing a dump process comprises:
collecting the segment information based on a determination whether the segment is partitioned.

12. The method of claim 11, further comprising dumping, if the segment is not partitioned, dumping the segment header to a temporary file based on a determination that the segment header does not have more than one free list group block.

13. The method of claim 11, further comprising collecting, if the segment is not partitioned, master free list information included in each of a plurality of free list groups included in the segment header and dumping the collected master free list information to a temporary file, wherein the master free list information reflects a total number of free data blocks for a corresponding free list group

14. The method of claim 11, further comprising locating, if the segment is partitioned, each of a plurality of partition segments included in the segment and dumping, to a temporary file, a partition segment header included in each partition segment.

15. The method of claim 1, further comprising:
providing a vital statistics report including the space availability information for the segment.

16. The method of claim 15, wherein the vital statistics report is provided periodically.

17. The method of claim 15, wherein providing the vital statistics report includes:
providing the vital statistics report to at least one of a printer device, a Web server, an electronic mail server, a display device, and a telephonic based computing system.

18. The method of claim 1, further comprising:
storing the space availability information for the segment in a historical data table that includes additional space availability information for the segment over a previous period of time; and
determining trend information reflecting a historical pattern of capacity changes of the segment based on the space availability information stored in the historical data table.

19. The method of claim 18, further comprising:
forecasting future space availability for the segment based on the determined trend associated with the capacity of the segment.

20. The method of claim 19, further comprising:
generating an output representation of the determined trend information; and
providing the output representation to a user.

21. The method of claim 1, wherein the segment is one of a table and an index.

22. A system for determining space availability information for a segment included in a tablespace associated with a database, the tablespace reflecting storage space included in the database, the system comprising:
means for identifying a segment included in the tablespace;
means for performing a dump process to collect segment information from a segment header included in the segment; and
means for determining the space availability information for the segment based on the collected segment information, wherein the space availability information includes at least one of used space for the segment, fractional space used by the segment in relation to an amount of space of the tablespace, available free space for the segment, and a number of new rows that may be inserted into the segment.

23. The system of claim 22, further comprising means for determining the used space for the segment by computing a difference between a total number of blocks below a High Water Mark (HWM) and a number of freelist blocks for the segment.

24. The system of claim 22, further comprising means for determining the fractional space used by the segment in relation to an amount of space of the tablespace by computing a total number of blocks below a High Water Mark (HWM) for the segment and dividing the total number of blocks by a total number of blocks assigned to the tablespace.

25. The system of claim 22, further comprising means for determining the available free space for the segment, the means for determining the available free space including:
means for determining a difference value between a total allocated space for the segment and a total number of blocks below a High Water Mark (HWM) for the segment;
means for determining a first value reflecting a relationship between a total number of freelist blocks for the segment and a percentage used value for the segment, wherein the percentage used value reflects a threshold value for each block in the segment that controls whether the corresponding block may be used to store new data;
means for determining a second value reflecting a relationship between a total number of free blocks in the tablespace and the fractional space used by the segment; and
means for summing the difference value, the first value, and the second value to determine the available free space for the segment.

26. The system of claim 22, further comprising means for determining the number of new rows that may be inserted into the segment by determining a row size for the segment and dividing the free space for the segment by the determined row size.

27. The system of claim 22, further comprising means for performing a post dump process to calculate a total number of rows in the segment.

28. The system of claim 27, wherein the means for performing a post dump process is configured to calculate the total number of rows in the segment based on a determination whether the segment has been analyzed by a database space availability analysis tool executed by the system.

29. The system of claim 28, further comprising means for obtaining the total number of rows for the segment from a dictionary table provided by the database space availability analysis tool.

30. The system of claim 28, further comprising means for performing a count process of a unique index associated with the segment to determine the total number of rows for the segment.

31. The system of claim 28, further comprising means for performing a full scan of the segment to determine the total number of rows for the segment.

32. The system of claim 22, wherein the dump process collects the segment information based on a determination whether the segment is partitioned.

33. The system of claim 32, wherein if the segment is not partitioned, the dump process dumps the segment header to a temporary file based on a determination that the segment header does not have more than one free list group block.

34. The system of claim 32, wherein if the segment is not partitioned, the dump process collects master free list information included in each of a plurality of free list groups included in the segment header and dumps the collected master free list information to a temporary file, wherein the master free list information reflects a total number of free data blocks for a corresponding free list group.

35. The system of claim 32, wherein if the segment is partitioned, the dump process locates each of a plurality of partition segments included in the segment and dumps, to a temporary data file, a partition segment header included in each partition segment.

36. The system of claim 22, further comprising means for generating a vital statistics report including the space availability information for the segment.

37. The system of claim 36, wherein the vital statistics report is provided periodically.

38. The system of claim 36, wherein the vital statistics report is provided to at least one of a printer device, a Web server, an electronic mail server, a display device, and a telephonic based computing system.

39. The system of claim 22, further comprising means for storing the space availability information for the segment in a historical table that includes additional space availability information for the segment over a previous period of time and means for determining trend information reflecting a historical pattern of capacity changes of the segment based on the space availability information stored in the historical data file.

40. The system of claim 39, further comprising means for forecasting future space availability for the segment based on the determined trend associated with the capacity of the segment.

41. The system of claim 39, means for generating an output representation of the determined trend information and providing the output representation to a user.

42. A computer-readable medium including instructions for performing a method, when executed by a processor, for determining space availability information for a tablespace of a database, the method comprising:
identifying a segment included in the tablespace;
performing a dump process that collects segment information from a segment header included in the segment; and
determining space availability information for the segment based on the segment information, wherein the space availability information includes at least one of used space for the segment, fractional space used by the segment in relation to an amount of space of the tablespace, available free space for the segment, and a number of new rows that may be inserted into the segment.

43. The computer-readable medium of claim 42, wherein determining space availability information comprises determining the used space for the segment by computing a difference between a total number of blocks below a High Water Mark (HWM) and a number of freelist blocks for the segment.

44. The computer-readable medium of claim 42, wherein determining space availability information comprises determining the fractional space used by the segment in relation to an amount of space of the tablespace, the determining the fractional space comprising:
computing a total number of blocks below a High Water Mark (HWM) for the segment; and
dividing the total number of blocks by a total number of blocks assigned to the tablespace.

45. The computer-readable medium of claim 42, wherein determining space availability information comprises determining the available free space for the segment, the determining the available free space for the segment comprising:
determining a difference value between a total allocated space for the segment and a total number of blocks below a High Water Mark (HWM) for the segment;
determining a first value reflecting a relationship between a total number of freelist blocks for the segment and a percentage used value for the segment, wherein the percentage used value reflects a threshold value for each block in the segment that controls whether the corresponding block may be used to store new data;
determining a second value reflecting a relationship between a total number of free blocks in the tablespace and the fractional space used by the segment; and
summing the difference value, the first value, and the second value to determine the available free space for the segment.

46. The computer-readable medium of claim 42, wherein determining space availability information includes determining the number of new rows that may be inserted into the segment, the determining the number of new rows that may be inserted into the segment comprising:
determining a row size for the segment; and
dividing the free space for the segment by the determined row size.

47. The computer-readable medium of claim 42, wherein the method further comprises:
performing a post dump process to determine a total number of rows in the segment.

48. The computer-readable medium of claim 47, wherein the post dump process includes:
determining the total number of rows in the segment based on a determination whether the segment has been analyzed by a database space availability analysis tool.

49. The computer-readable medium of claim 48, wherein if the segment has been analyzed by the database space availability analysis tool, the method includes:
obtaining the total number of rows for the segment from a dictionary table provided by the database space availability analysis tool.

50. The computer-readable medium of claim 48, wherein if the segment has not been analyzed by the database space availability analysis tool, the method includes:
performing a count of a unique index associated with the segment to determine the total number of rows for the segment.

51. The computer-readable medium of claim 48, wherein if the segment has not been analyzed by the database space availability analysis tool, the method includes:
performing a full scan of the segment to determine the total number of rows for the segment.

52. The computer-readable medium of claim 42, wherein performing a dump process includes:
collecting the segment information based on a determination whether the segment is partitioned.

53. The computer-readable medium of claim 52, wherein if the segment is not partitioned, the dump process includes:
dumping the segment header to a temporary file based on a determination that the segment header does not have more than one free list group block.

54. The computer-readable medium of claim 52, wherein if the segment is not partitioned, the dump process includes:
collecting master free list information included in each of a plurality of free list groups included in the segment header; and
dumping the collected master free list information to a temporary file, wherein the master free list information reflects a total number of free data blocks for a corresponding free list group

55. The computer-readable medium of claim 52, wherein if the segment is partitioned, the dump process includes:
locating each of a plurality of partition segments included in the segment; and
dumping, to a temporary file, a partition segment header included in each partition segment.

56. The computer-readable medium of claim 42, wherein the method further comprises:
providing a vital statistics report including the space availability information for the segment.

57. The computer-readable medium of claim 56, wherein the vital statistics report is provided periodically.

58. The computer-readable medium of claim 56, wherein providing the vital statistics report includes:
providing the vital statistics report to at least one of a printer device, a Web server, an electronic mail server, a display device, and a telephonic based computing system.

59. The computer-readable medium of claim 42, wherein the method further comprises:
storing the space availability information for the segment in a historical data file that includes additional space availability information for the segment over a previous period of time; and
determining trend information reflecting a historical pattern of capacity changes of the segment based on the space availability information stored in the historical data file.

60. The computer-readable medium of claim 59, wherein the method further comprises:
forecasting future space availability for the segment based on the determined trend associated with the capacity of the segment.

61. The computer-readable medium of claim 60, wherein the method further comprises:
generating an output representation of the determined trend information; and
providing the output representation to a user.
